(19) United States
(12) Patent Application Publication
(10) Pub. No.: US 2013/0341821 A1
(43) Pub. Date: Dec. 26, 2013

(54) Environmental Friendly Method to Produce Artificial Rocks and Other Items with Recycled Materials

(71) Applicant: Koon Shing Chan, Ontario, CA (US)

(72) Inventor: Koon Shing Chan, Ontario, CA (US)

(21) Appl. No.: 13/436,837

(22) Filed: Jun. 21, 2012

(51) Int. Cl. B29C 33/38

(52) U.S. Cl. 264/219

(57) ABSTRACT

A method to produce artificial rock which includes the following steps: (1) Lay down a piece of plastic film as a working surface. Prepare a mold with plastic bags, used bottles, containers and papers. Tape the outside of the plastic bag with adhesive tape to secure all the contents. Put extra plastic bags for extra protection for the inside stuffing containers. (2) Apply the pre-mixed cement mixture on top of the mold. (3) Spray the article with color paint. (4) Obtain a finish product. The method is an environmental way to turn household unwanted items into useful household and commercial building decorations and containers which can largely reduce the cost of production and simplified the production process. The stuffing bottles, containers and papers can be arranged randomly into different shapes and sizes according the actual demands and application requirements. The products itself can also be recycled into building material.

### CROSS REFERENCE OF RELATED APPLICATION

This is a non-provisional application that claims the benefit of priority under 35 U.S.C.§119 to a provisional application, application number 61/516,120, filed Mar. 30, 2011.

### BACKGROUND OF THE PRESENT INVENTION

1. Field of Invention

The present invention relates to making artificial rocks and other items by using unwanted bottles, wasted containers, unwanted news paper and used plastic bag as raw materials to create a mold. The process utilizes wasted materials and creates useful products and does not consume new material for making a mold of the finished product.

2. Description of Related Arts

Artificial rocks gain popularity in home and commercial decoration and gardening as it can be molded into any shapes and sizes. The weight of an artificial rock is significantly lighter than a real rock so it eases the trouble of transportation. The conventional method for making an artificial rock is by creating a mold using chicken wire to wrap a form or by other materials. However, this method is very time consuming and also requires new materials for the production.

### SUMMARY OF THE PRESENT INVENTION

Since the importance of environmental protection and the conservation of natural resources has gained public awareness. My innovative way of making artificial rocks and other items is by using unwanted bottles, wasted containers, unwanted news paper and used plastic bag as raw materials to create a mold. Thus the process utilizes wasted materials and creates useful products. The production does not consume new material for making a mold of the finished product.

The molding of my invention is made from used materials such as bottles. The stuffing containers can be removed after used. The artificial rock production process will not damage the molding containers. Therefore it is possible to reuse the mold for multiple productions.

After creating the mold, one can use pre-mixed cement to create an artificial rock or other items. Compare with using ceramic, cement require no extra heat energy during the production and is more durable. With creativity and minimum skill, the finish products can be highly marketable and profitable. The versatility of the products can be created to suit many applications for home owners or for commercial uses.

The described products can be used outdoor or indoor. The finished products are also recyclable as those can be broken into piece and used as a mixing substance for a new concrete structure.

According to the present invention, the foregoing and other objects and advantages are attained by a method of making an artificial rock, comprising the following steps:

1. The first step of the production is to collect various sizes of used bottles, containers and unwanted news papers, papers and plastic bags. The materials can be plastic bottles, aluminum cans or even cardboard containers. Arrange the used bottle and papers into different shapes and bundle them with tape.

2. Fill up all the spaces between the used bottle with news paper or recycled paper. Cover the mold prepared from step 1 with a plastic bag. Use a plastic bag to wrap up all the containers and filing materials. This allows a thin layer of plastic covering the gaps between each container. Thus minimize the amount of cement needed to fill up the space. The plastic bag film can also protect the containers from getting direct contact with the cement and make reusing them possible.

3. Use tape to secure the positions of all the contents inside the plastic bag and put an extra plastic bag as needed.

4. Put a piece of smooth plastic film on a flat floor or surface, this will serve as a working station. Put the mold on top of the plastic layer.

5. Apply pre-mixed cement, sand and water mixture to the mold to a 1 to 3 inches thickness according to the size of the rock. Add fiber reinforcement into the pre-mixed cement if necessary.

6. Allow the rock to cure for 1 week.

7. Removed the mold by withdrawing the bottles from the bottom of the article.

8. The last step is to furbish the piece with spray paint.

9. A hollow artificial rock structure is now finished.

### BRIEF DESCRIPTION OF THE DRAWINGS

FIGS. 1 to 4 are illustrations of a method of making artificial rock according to a preferred embodiment of the present invention.

### DETAILED DESCRIPTION OF THE PREFERRED EMBODIMENT

Detail steps for making an artificial rock or other item is described as follow:

The first step of the production is to collect various sizes of used bottles, containers and unwanted news papers, papers and plastic bags. The materials can be plastic bottles, aluminum cans or even cardboard containers. Arrange the used bottle and papers into different shapes and bundle them with tape.

Fill up all the spaces between the used bottle with news paper or recycled paper. Cover the mold prepared from step 1 with a plastic bag. Use a plastic bag to wrap up all the containers and filing materials. This allows a thin layer of plastic covering the gaps between each container. Thus minimize the amount of cement needed to fill up the space. The plastic bag film can also protect the containers from getting direct contact with the cement and make reusing them possible. (Please also refer to FIG. 1. in the illustration drawing)

Use tape to secure the positions of all the contents inside the plastic bag and put an extra plastic bag as needed. (Please refer to FIG. 1 in the illustration)

Put a piece of smooth plastic film on a flat floor or surface, this will serve as a working station. Put the mold on top of the plastic layer.

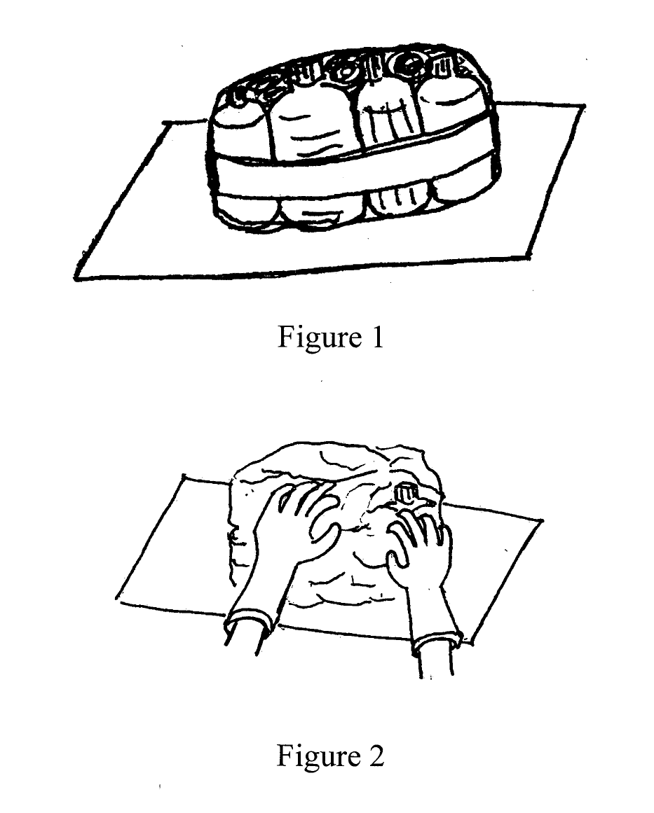

Apply pre-mixed cement, sand and water mixture to the mold to a 1 to 3 inches thickness according to the size of the rock. Add fiber reinforcement into the pre-mixed cement if necessary. (Please see FIG. 2 in the illustration)

Allow the rock to cure for 1 week.

Removed the mold by withdrawing the bottles from the bottom of the article.

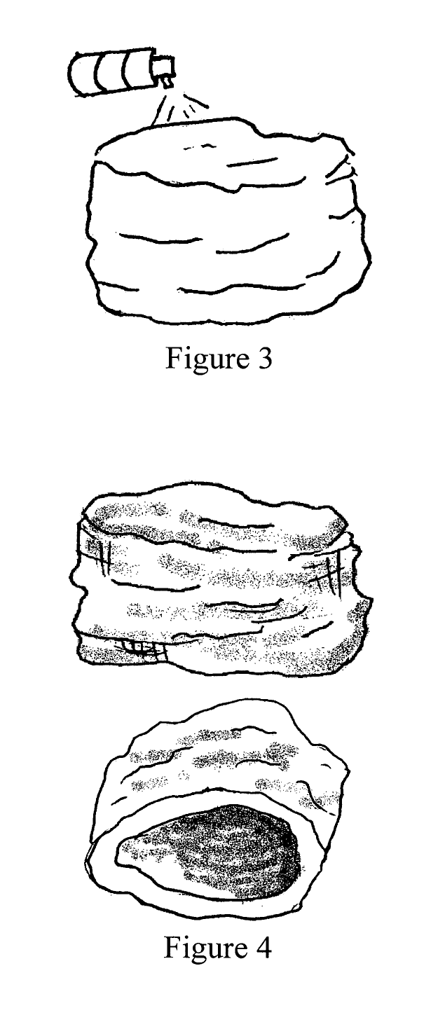

The last step is to furbish the piece with spray paint. (Please see FIG. 3 in the illustration.

A hollow artificial rock structure is now finished. (Please see FIG. 4 for a sample appearance of the artificial rock.)

In particular, referring to FIGS. 1 to 4 of the drawings, the present invention is further illustrated and described as follows:

FIG. 1. Lay down a piece of plastic film as a working surface. Prepare a mold with plastic bags, used bottles, containers and papers. Tape the outside of the plastic bag with adhesive tape to secure all the contents. Put extra plastic bags for extra protection for the inside stuffing containers.

FIG. 2. Apply the pre-mixed cement mixture on top of the mold.

FIG. 3. Spray the article with color paint.

FIG. 4. The front and the bottom views of the finish product is illustrated.

I have invented an environmental way to turn household unwanted items into useful household and commercial building decorations and containers. By using the described materials and method for artificial rocks and other items can largely reduce the cost of production and simplified the production process. The said stuffing bottles, containers and papers can be arranged randomly into different shapes and sizes according the actual demands and applications of the finished products. The production process is being simplified as no special skill is required.

The finish products can be used outdoor and indoor for home and commercial applications. The products itself can be recycled into building material as well.

What is claimed is:

1. A method to produce an artificial rocks, comprising the steps of:
(a) laying down a piece of plastic film as a working surface;
(b) preparing a mold with recycled materials;
(c) tapping the mold to secure the recycled materials;
(d) applying a pre-mixed cement mixture on top of the mold to form an article;
(e) spraying a color paint onto the article; and
(f) obtaining a finished product.

2. The method to produce an artificial rocks, as recited in claim 1, wherein the recycled materials at least comprises one or more plastic bag provided as an exterior layer of the mold such that the plastic bag is capable of being tapped with adhesive tape so as to secure the recycled materials and provide protection to a stuffing layer of the mold.

3. The method to produce an artificial rocks, as recited in claim 1, wherein the recycled materials consists of one or more plastic bag and at least one used bottle, container or paper, wherein the used bottle, the container or the paper can be arranged randomly into different shapes and sizes for producing the finished product with different shapes and sizes.
